(19) United States
(12) Patent Application Publication
(10) Pub. No.: US 2025/0196026 A1
(43) Pub. Date: Jun. 19, 2025

(54) FILTRATION SYSTEMS AND METHODS OF OPERATION

(71) Applicant: SPECIALTY MINERALS (MICHIGAN) INC., Plymouth, MI (US)

(72) Inventors: Shaya MOVAFAGHIAN, Houston, TX (US); Elliot HALPHEN, Youngsville, LA (US); Jeff LANCON, Lafayette, LA (US)

(21) Appl. No.: 19/063,227

(22) Filed: Feb. 25, 2025

Related U.S. Application Data
(63) Continuation of application No. PCT/US2023/073636, filed on Sep. 7, 2023.
(60) Provisional application No. 63/406,690, filed on Sep. 14, 2022.

(51) Int. Cl. B01D 17/04; B01D 24/04; B01D 24/48

(52) U.S. Cl. CPC B01D 17/045; B01D 24/04; B01D 24/4815

(57) ABSTRACT

A hydrocarbon filtration system is provided for removing a contaminant. The filtration system includes a housing unit; a porous compressible filtration media disposing within the housing unit; and a lower and upper perforated plates in between which the porous compressible filtration media is disposed. At least one of the upper or lower perforated plate is movable relative to the other perforated plate for compressing and decompressing the porous compressible filtration media. A coalescence promoting device is positioned within the housing unit and above the upper perforated plate. The coalescence promoting device is configured to promote the coalescence of a hydrocarbon in the housing unit. Also provided is a method of treating hydrocarbon containing fluid by performing a filtration cycle followed by performing a wash cycle to wash a contaminant from the filtration media. During the wash cycle, an upper segment of the housing unit between an upper wall of the housing unit and the filtration media can be a gas-free zone.

### FIELD

The inventions relate to filtration systems, such as filtration systems for separation of contaminant(s) from a carrier fluid. The filtration system can be used, for example, in treatment of processed or effluent water, produced during or as the result of industrial, municipal, petrochemical, refining, oil, and/or gas process or production operations. The inventions further relate to methods for filtering carrier fluids produced in these operations.

### BACKGROUND

Fluids generated during or as the result of industrial, municipal, petrochemical, refining, oil, and/or gas process or production operations contain contaminants such as dispersed oil, solid particulates, and chemical additives. It is imperative to include a filtration stage during various operational phases to remove the contaminants. Removal of contaminants protects downstream apparatus and, in some cases, is obligatory for meeting regulatory and environmental discharge requirements for the treated fluids.

A compressible porous filtration media is one example of a filtration device for removing contaminants. The pores of the filtration media are smaller in its compressed state as compared to its decompressed state, thus allowing for effective trapping of the contaminants, including small particle sizes. The filtration media in its compressed state can filter contaminants of both small and larger sizes. Over time, the filtration media reaches its capacity to capture contaminants and eventually fails to effectively remove the contaminants from an influent stream. Therefore, the filtration media requires periodic cleansing to wash the filtration media and remove the captured contaminants. This cleansing step is done when the filtration media is in a decompressed state. A cleansing fluid is injected through the filtration media to remove the contaminants and to carry the contaminants out of the filtration apparatus. Expansion of the filter's matrix allows the contaminants that have been trapped to be more easily dislodged and removed from the filtration media.

In addition to a cleansing fluid, current commercially available systems utilize air or a scouring gas to further facilitate dislodgment and removal of the contaminants from the filtration media. A gas system supplies a scouring gas to the cleansing fluid for exerting mild agitation to the filtration media. The agitation further enables the cleansing fluid to remove the contaminants. The use of a scouring gas, however, limits the application of such filtration systems. The use of a scouring gas requires implementation of a system that would supply and discharge the gas during the cleansing cycle. For example, in remote production operations, access to a suitably refined gas source and an adequate amount of gaseous medium for consumption is a restraining factor that makes it difficult, if not impossible, to use these commercial filtration systems. Another limitation lies in sensitivity of the processing fluids to ingress of a gaseous medium. Air, for example, is one such gaseous medium, which is dominantly used in municipal and some industrial applications but cannot be used in other applications sensitive to oxygen. Oxygen ingress, as the result of introduction of such gaseous medium into the process fluids, will result in oxidation reactions that will undermine the quality of the processed fluids, create unwanted oxidized and corroded products, and jeopardize the mechanical integrity of the processing facilities. Thus, a gas-scouring step for cleansing commercial filtration systems, if not limiting their application, imposes cost penalties for production and delivery of a chemically neutral gas suitable for a given process. Additionally, using a scouring gas creates the need for production facilities to manage a liquid waste that contains a scouring gas. Not all receiving facilities are designed to handle waste containing a gaseous medium in conjunction with a liquid phase medium.

Another problem with current filtration systems is the inability to maintain an acceptable amount or concentration of the dispersed phase or phases produced from the filtration system. In one example, the dispersed hydrocarbons in liquid phase, forming an emulsion, tend to coalesce on the surface of the filtration medium. The hydrocarbon will be released back into the treated fluid, which in turn causes inadequate separation and removal of hydrocarbon waste from the filtration system.

The various embodiments of the present inventions eliminate the use of a gaseous medium from the filter system, thus increasing the number of applications for which the filter can be used. In addition, the embodiments of the present inventions allow for more effective removal of the dispersed phase(s) from the filtration system, thus minimizing the amount of contaminants remaining in filtrate carried out of the filtration system during the filtration process. The proposed filtration systems and methods improve operational performance and off-line time by reducing the number of steps and sequences as well as overall time required to complete the cleansing stage.

### SUMMARY

One aspect of the invention is directed at a hydrocarbon filtration system for removing a contaminant. The filtration system comprises a housing unit; a porous compressible filtration media disposed within the housing unit; and lower and upper perforated plates in between which the porous compressible filtration media is disposed. At least one of the upper perforated plate or lower perforated plate can be movable relative to the other perforated plate for compressing and decompressing the porous compressible filtration media. An inlet line is configured to receive a wash fluid for removing a contaminant from the porous compressible filtration media when the porous compressible filtration media is in a decompressed state. An outlet line is provided through which the wash fluid is discharged along with the removed contaminant. The filtration system can include a coalescence promoting device positioned within the housing unit and above the upper perforated plate. The coalescence promoting device is configured to promote the coalescence of a hydrocarbon in the housing unit. The filtration system can further include a second outlet line configured to be used to remove coalesced hydrocarbon from the housing unit.

In one embodiment, the housing unit comprises a coalesced hydrocarbon collection zone above the coalescence promoting device and below an upper wall of the housing unit. The coalesced hydrocarbon collection zone provides an area in an upper most area of the housing unit where the coalesced hydrocarbon is collected.

In one embodiment, the coalescence promoting device can include a hollow upper cylindrical segment of a constant inner diameter extending into a hollow lower conical segment of a variable inner diameter. The cylindrical segment can extend at an angle into conical segment, or the transition can be gradual, such as having a curvature. The variable inner diameter increases away from the upper cylindrical segment of the constant inner diameter.

Other variations to the above embodiments can be implemented, such as the lower segment can be domed-shape. In one embodiment, the upper and/or lower segment can be elliptical or oval in cross-section, instead of circular. In another embodiment, the hollow upper segment can be cylindrical having a constant inner diameter and the hollow lower segment can be cylindrical having a constant inner diameter. The constant inner diameter of the upper segment can be smaller than the constant inner diameter of the lower segment.

In accordance with another aspect of the invention, a hydrocarbon filtration system for removing a contaminant is provided. The system comprises a housing unit and a coalescence promoting device positioned within the housing unit and configured to promote the coalescence of a hydrocarbon in the housing unit. A ratio of a Reynolds number at the exit of the coalescence promoting device to a Reynolds number at the entrance of the coalescence promoting device is between 1.4 to 3.3, preferably 2.2 to 3.1.

In accordance with another aspect of the invention, a method of filtering a contaminant from a carrier fluid is provided. The method can include directing a carrier fluid in need of filtration into the housing unit of the filtration system to filter the fluid with the filtration media. A fluid that has been filtered by the filtration media is discharged out of the housing unit. A wash fluid is directed into the housing unit for washing the filtration media. The wash fluid is discharged out of the housing unit to remove a contaminant washed from the filtration media. The method further includes periodically removing a coalesced hydrocarbon from the housing unit. During the directing of the carrier fluid the filtration media can be in a compressed state. During the directing of the wash fluid the filtration media can be in a decompressed state. In accordance with one preferred embodiment, during the directing of the wash fluid no gases are introduced into the wash fluid or the housing unit to avoid having a liquid-free zone in the housing unit in an area above the coalescence promoting device. The compressed state can be performed by actuating the upper plate down and towards the lower plate to compress the filtration media to create a porosity gradient in the filtration media for removal of the contaminant. The decompressed state can be performed by moving the upper plate up and away from the lower plate to cause the filtration media to expand from the compressed state to the decompressed state to facilitate the removal of the contaminant captured by the filtration media by the wash fluid. During the directing of the wash fluid and discharging of the wash fluid, a space below an upper wall of the housing unit and above the coalescence promoting device is free from any gases accumulated as the result of and intended for assistance in washing the filtration media from contaminants.

In accordance with another aspect of the invention, a method of treating a hydrocarbon containing fluid is provided. The method comprises performing a filtration cycle with a chamber housing a filter medium to filter a contaminant from a hydrocarbon containing fluid; and performing a wash cycle to wash the filter and to remove the contaminant from the filter medium. During the wash cycle, an upper segment of the chamber below an upper wall of the chamber and above the filter is a gas-free zone, from any gases accumulated as the result of and intended for assistance in washing the filter medium from contaminants. In one embodiment, the chamber includes a coalescence promoting device to promote the coalescence of the hydrocarbon so as to facilitate the collection of the coalesced hydrocarbon in the gas-free zone and removal of the coalesced hydrocarbon from the chamber. Thus, the method further comprises performing removal of the coalesced hydrocarbon from the chamber. The removal of the coalesced hydrocarbon can be done during the wash cycle. The removal of the coalesced hydrocarbon can be performed at least once during the filtration cycle and can be performed at least once during the wash cycle. The coalescence promoting device can include a hollow upper cylindrical segment of a constant inner diameter extending into a hollow lower conical segment of a variable inner diameter, the variable diameter increases away from the upper cylindrical segment of the constant diameter. Other variations can be used as disclosed herein. The method can additionally comprise performing a decompression step prior the wash cycle to decompress the filter medium; and performing a compression step after the wash cycle and before the filtration cycle to compress the filter medium. In one embodiment, the chamber houses a perforated upper plate and a perforated lower plate positioned at a distance below the perforated upper plate, the filter medium being disposed between the perforated upper and lower plates. The perforated upper plate is moved away from the perforated lower plate for the decompression step and the perforated upper plate is moved towards the perforated lower plate for the compression step. In a preferred embodiment, in the wash cycle, a wash fluid is introduced into the chamber via an inlet line, is passed through the filter medium for removal of the contaminant, and is exited through an outline line, with the proviso that no gas (e.g., air or scouring gas) is added to the wash fluid and introduced into the chamber during the wash cycle so as to create the gas-free zone in the upper segment of the chamber.

In accordance with another aspect of the invention, the hydrocarbon filtration system comprises the housing unit; the compressible filtration media disposed within the housing unit; and the lower and upper perforated plates in between which the compressible filtration media is disposed, wherein at least one of the upper or lower perforated plate is movable relative to the other perforated plate for providing a compressed state and a decompressed state for the compressible filtration media. At least one axial nozzle penetrates through the lower perforated plate for supplying a wash fluid to the filtration media. At least one radial nozzle can be positioned above the lower perforated plate for supplying the wash fluid to the filtration medial. The wash fluid is configured to be supplied to remove a contaminant from the compressible filtration media when the compressible filtration media is in the decompressed state. In accordance to one embodiment, the radial nozzle can be positioned below the upper perforated plate when the filtration media is at the decompressed state. The hydrocarbon filtration system can additionally comprise the coalescence promoting device positioned within the housing unit and above the upper perforated plate.

In accordance to another aspect of the invention, a method of filtering a contaminant from a carrier fluid is provided. The method comprises directing a carrier fluid in need of filtration into the housing unit of the filtration system having the axial and radial nozzles to filter the carrier fluid with the filtration media in the compresses state. The fluid that has been filtered by the filtration media is discharged out of the housing unit. A wash fluid is directed into the housing unit and discharged out of the axial and radial nozzles for washing the filtration media in the decompressed state.

In accordance to another aspect of the invention, the hydrocarbon filtration system comprises an external flow loop circulating device for circulating the wash fluid out of the housing unit and back into the housing unit. The external circulating device comprises a circulating inlet line for receiving the wash fluid from the housing unit and a circulating outlet line for supplying the wash fluid back into the housing unit. In one embodiment, the circulating inlet and outlet lines are in communication with the housing unit at positions between the lower and upper perforated plates when the filtration media is at the decompressed state.

In accordance to another aspect of the invention, a method of filtering a contaminant from a carrier fluid is provided. The method comprises directing a carrier fluid in need of filtration into the housing unit of the filtration system having the external flow loop circulating device to filter the carrier fluid with the filtration media in the compressed state. The fluid that has been filtered by the filtration media is discharged out of the housing unit. A wash fluid is directed into the housing unit for washing the filtration media in the decompressed state. A volume of the wash fluid is discharged out of the housing unit to remove a contaminant washed from the filtration media. A volume of the wash fluid is circulated out of the housing unit and back into the housing unit.

### BRIEF DESCRIPTION OF THE DRAWINGS

FIG. 1 is a schematic of a hydrocarbon filtration system in accordance with one embodiment of the present invention.

FIG. 2A is a coalescence promoting device in accordance with one embodiment of the present invention that is configured to be implemented with the embodiments of the hydrocarbon filtration system.

FIG. 2B is a coalescence promoting device in accordance with another embodiment of the present invention that is configured to be implemented with the embodiments of the hydrocarbon filtration system.

FIG. 2C is a coalescence promoting device in accordance with another embodiment of the present invention that is configured to be implemented with the embodiments of the hydrocarbon filtration system.

FIG. 2D is a coalescence promoting device in accordance with another embodiment of the present invention that is configured to be implemented with the embodiments of the hydrocarbon filtration system.

FIG. 3 illustrates an example of the process steps for using the various embodiments of the hydrocarbon filtration systems.

FIG. 4 illustrates a range of dimensionless hydrodynamic groups.

FIG. 5A is a schematic of a hydrocarbon filtration system in accordance with another embodiment of the present invention.

FIG. 5B is a schematic of a hydrocarbon filtration system in accordance with another embodiment of the present invention.

FIG. 5C is a schematic of a hydrocarbon filtration system in accordance with another embodiment of the present invention.

FIG. 6 is the graphical representation of Table 3.

### DESCRIPTION OF EXEMPLARY EMBODIMENTS

The inventions relate to filtration systems, such as filtration systems for separation of contaminant(s) from a carrier fluid. The carrier fluid can take, for example, the form of a continuous liquid phase mixed with one or more dispersed contaminants. More particularly, the filtration system can be used in treatment of processed or effluent water produced during or as the result of industrial, municipal, petrochemical, refining, oil, and/or gas process or production operations. The inventions further relate to methods for filtering fluids produced in said operations, including washing of the filtration system.

“Carrier fluid” refers to any type of fluid that carries a contaminant in need of filtration. One example of carrier fluid that can be filtered with the embodiments of the invention is oil and/or gas-type fluid. “Oil and/or gas-type fluid” refers to any type of fluid generated preproduction, during production, and/or post-production of an industrial operation, a municipal operation, a petrochemical operation, a refining operation, or an oil and/or gas operation. Carrier fluid includes contaminants such as, for example, oil in dispersed phase and solid particulates, in need of filtration and removal so that, for example, downstream apparatus can be protected and/or regulatory and environmental discharge requirements can be met. In various forms of oil and/or gas production, produced and natural water streams are generated that must be treated for disposal or reuse.

“Continuous liquid phase” takes its ordinary chemistry definition, meaning, for example, a liquid in a disperse system in which solids are suspended or droplets of another liquid are dispersed or distributed. Continuous liquid phase is also referred to as dispersion medium.

“Dispersed phase” also takes its ordinary chemistry definition, meaning, for example, that a phase in a two-phase system that includes finely divided particles (e.g., colloidal particles), droplets, or bubbles of one substance distributed through another substance. Dispersed phase can also be referred to as a discontinuous phase. The dispersed phase can take the form of a liquid phase or plurality of liquid phases or a solid phase or plurality of solid phases.

The term “fluid” takes its ordinary chemistry definition, and refers to a substance that has no fixed shaped and yields easily to external pressure. A fluid can be a gas or a liquid.

The term “liquid” takes its ordinary chemistry definition, and refers to a substance that flows freely but is of constant volume, having a consistency like that of water or oil.

The term “gas” takes its ordinary chemistry definition, and refers to a substance or matter in a state in which it will expand freely to fill the whole of a container, having no fixed shape (unlike a solid) and no fixed volume (unlike a liquid).

Examples of carrier fluid can include, but are not limited to, “produced water” and “flowback water.” “Produced water” is defined as naturally occurring formation water that is high in gas and oil. “Flowback water” is defined as water that includes non-natural constituents or synthetically created chemical additives following treatment of a well and is usually referred to as return of injected fluids. After the water is pumped into the subterranean rock formations, a significant amount flows back to the earth's surface. The liquid flowing to back out of the earth's surface may transition from flowback water to produced water. Produced water typically flows to the surface, together with the produced oil and/or natural gas, throughout the lifespan of a well.

“Wash fluid” refers to any liquid having physical and/or chemical characteristics to remove contaminants from a filter bed, filtration media, or filtration medium, such as a porous compressible filtration media. The wash fluid can act to dislodge and remove containments from the filtration media and further acts as a transport for removal of the dislodged or loosened contaminants out from the filtration housing or chamber. Examples of wash fluid include a portion of the filtrate from the filtration system effluent, clean or relatively clean fluid from a readily available source, or an influent fluid of a fluid system with which the filtration media is used. Wash fluid from any source may be used in conjunction with additional chemicals to enhance the cleansing of the filter media. In one embodiment, the wash fluid contains no gases, either provided with the wash fluid or pumped separately into the wash fluid during the cleaning or wash cycle. For example, no scouring gas is introduced concomitantly with the wash fluid to agitate the filtration media for dislodging of the contaminants. One objective of not having any gases (i.e., gas free-zone) is to eliminate a liquid-free zone at the top of the filtration housing or chamber. The top of a filtration housing or chamber is filled with the wash fluid in which the hydrocarbons are allowed to coalesce from the emulsion for more efficient removal of the hydrocarbons from the filtration system.

“A gas-free zone” is defined as having no gases because of elimination of any gases accumulated as a result of and intended for assistance in washing the filtration media from contaminants. That is, a gas-free zone is created when the wash fluid contains no gases, either provided with the wash fluid or pumped separately into the wash fluid during the cleaning or wash cycle. However, a gas-free zone can include a low or negligible volume of a gas or a vapor that is produced by, entrained from, or flashed-off a fluid during normal course of operation.

Examples of “contaminants” can include one or a combination of solid particulates, dissolved solids, clays, chemical additives, dissolved metal ions, salts, oil and hydrocarbon wastes (e.g., paraffins, naphthenes, and aromatics), greases, and/or organic contaminant molecules.

As used herein, the filtration, filtration bed, filtration medium, or filtration media—terms which are used interchangeably—can mean any material that is effective for capturing a contaminant from a carrier fluid when the fluid is passed through the filtration media. The filtration media can be of any type configured to capture designated contaminants when a carrier fluid passes through the media. The filtration media can be a synthetic filtration media, meaning one that includes synthetic fibers. The fibers can form a porous network or trapping points that are designed to capture a contaminant when a fluid stream is passed through the media. In one preferred embodiment, the filtration media is a porous compressible filtration media.

As used herein, “compressible filtration media” can refer to a porous filtration media, including a synthetic type, where the filtration media forms a porosity gradient when a compression force is applied to it. When the compression force is removed, the compressible filtration media can expand to cause its porosity to also expand or widen to allow for easier dislodgment and removal of contaminants captured by the filtration media. Compressible filtration media can include, for example, fibrous lumps that are configured to be compressed and decompressed. When compressed, the filtration media can harbor a porosity gradient proceeding progressively from more porous to less porous in the direction of the flow of the fluid that is to be filtered. That is, filtration is in the direction of more porous to less porous to capture larger sized contaminants at the point of fluid entry and smaller sized contaminants are captured at the point of fluid exit.

As used herein the term “control volume” can refer to the finite volume of the fluid within the housing unit or the filtration tank, which is confined between a lower perforated plate and an upper perforated plate as described herein. In one example, the control volume is the finite volume occupied by the filtration media and fluid between the lower perforated plate and upper perforated plate when the perforated plates are exerting a compression force on the filtration media. In another example, control volume refers to the finite volume between the lower perforated plate and upper perforated plate when the perforated plates are not exerting compression on the filtration media and thus the filtration media particles are free to move about the space between the lower and upper perforated plates.

As used herein, the singular forms “a”, “an,” and “the” are intended to include the plural forms and plural is intended to include singular, unless the context clearly indicates otherwise (such as, for example, with the use of the term “one” or “plurality”). Thus, “a media” can include more than one media, for example stacked layers of the filtration media or a combination of two different filtration media, unless otherwise specifically indicated that it is in single form.

As used herein, the term “and/or” includes one or any combinations of one or more of the associated listed items.

A filtration process basically has two main cycles, the filtration cycle and the wash cycle. Filtration cycle refers to the removal of a contaminant from an influent stream of a carrier fluid to be filtered and optionally treated downstream. The wash cycle is to remove the captured contaminant and to clean and regenerate the filtration media. One concept of the present filtration systems is to remove contaminant from the influent stream of a carrier fluid and produce an effluent stream that contains a reduced number, amount, or concentration of the contaminant, or ideally no or negligible contaminants. Over time, the filtration media reaches its intended filtration capability or its contamination capture capacity. When filtration media reaches its threshold capacity, it will exert an excessive differential pressure on the upstream process. Therefore, the filtration system requires periodic cleaning, referred to as the wash cycle, to remove the captured contaminant from the filtration media. In addition to removal of a contaminant, removal of re-entrained hydrocarbon phase or hydrocarbon waste from the filtration system is also needed to reduce the amount or concentration of hydrocarbon waste from the effluent stream of the filtration cycle and/or the wash cycle. Because during filtration cycle the hydrocarbon is present as a re-entrained dispersed phase or an emulsion in the filtration system, separation and removal of hydrocarbon waste has been a problem. The various aspects of the present invention are directed at systems and methods for improving the removal of residual hydrocarbon or hydrocarbon waste from the filtration system so as to minimize the amount or concentration of the hydrocarbon waste that exits the effluent stream during the filtration and/or wash cycles.

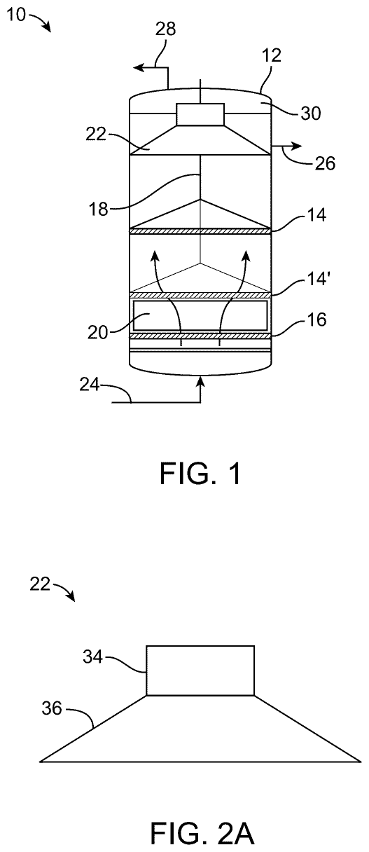

Referring now in more detail to the exemplary drawings for purposes of illustrating exemplary aspects of the inventions, wherein like reference numerals designate corresponding or like elements among the several views, there is shown in FIG. 1 an embodiment of a filtration system 10 for cleaning carrier fluids, such as, for example, flowback water or produced water in oil or natural gas production operations. The filtration system includes a housing unit, tank, or chamber 12 encompassing an internal volume. An upper perforated plate 14 and a lower perforated plate 16 are positioned in the housing unit 12. In one embodiment, with the use of a compressible filtration media, the upper 14 and lower 16 plates move towards and away from each other to create a compressed state and a decompressed state of the filtration media. The upper plate 14 can be raised and lowered within the housing unit 12 while the lower plate 16 is stationary or fixed to the housing unit 12, the lower plate 16 can be raised and lowered within the housing unit 12 while the upper plate 14 is stationary or fixed to the housing unit 12, or a combination of both upper 14 and lower 16 plates can be raised and lowered with respect to each other. In FIG. 1, the upper plate is shown in its decompression position 14 and its compression position 14′. In the decompression position 14, the upper plate has a greater distance from the lower plate 16 than in the decompression position 14′. In the compression position 14′, a compression force is applied to the filtration bed to create a porosity gradient extending thickness-wise in the filtration bed.

FIG. 1 illustrates an actuator 18 that can be used to raise and lower the upper plate 14. A similar actuator can be used for the lower plate 16. The actuator 18 can be a pneumatic or hydraulic type device having a piston used to move the plate in an up-and-down fashion. The actuator 18 can also be a bar that is moved by gears and a motor. The actuator 18 can be installed externally or internally of the housing unit 12. An externally installed actuator can extend fully outside the housing unit 12, partially outside the housing unit 12, or placed in a separate housing and extended into the housing unit 12. Internally installed actuator can be placed submerged into the fluid occupying the housing unit 12.

A filtration media 20 is contained between the upper 14 and lower 16 plates. In the embodiment of the upper plate 14 and lower plate 16 moving with respect to each other, the filtration media can be compressed when the upper plate 14 is moved closer to the lower plate 16 and oppositely decompressed when the plates 14 and 16 are moved way with respect to each other. The filtration system 20 is in the filtration cycle when the filtration media 20 is in the compressed state and in the wash cycle when the filtration media 20 is in the decompressed state. In the compressed stated, the filtration media 20 harbors a gradient porosity for capturing contaminants of different sizes. The porosity gradient is least porous from the area where compressive force has been applied and becomes progressively more porous as the distance from the compressive force increases. As illustrated in the example of FIG. 1, the filtration media 20 is more porous at the influent side and becomes progressively less porous along its thickness towards the effluent side. Thus, larger sized contaminants are initially retained or captured followed by filtration of the smaller sized contaminants towards the upper end of the filtration media 20.

The filtration system 10 of FIG. 1 is illustrated has having an influent or inlet line 24 through which carrier fluid and wash fluid can be introduced into the housing unit 12 and an effluent or outlet line 26 through which the filtered carrier fluid and the wash fluid can be discharged. While the filtration system 10 is illustrated as having a shared influent 24 and effluent 26 lines for use in both the filtration cycle and the wash cycle, additional and separate influent lines and/or separate effluent lines can be incorporated into the filtration system 10 to accommodate the injection and discharge of the different types of fluids. The filtration system 10 additionally includes a bleed out line 28, positioned on the top of the housing unit 12, for periodic removal of the coalesced hydrocarbon.

The filtration system 10 can include a coalescence promoting device 22 coupled within the housing to promote the coalescence of the hydrocarbon from an emulsion so as to allow removal of higher quantity of the hydrocarbon waste from the housing as compared to a housing that does not include the coalescence promoting device. The coalescence promoting device 22 is coupled above the upper plate 14 and below an upper wall of housing unit 12. As can be best seen from FIG. 1, the coalescence promoting device 22 can divide the housing unit or chamber 12 into two separate or individually divided compartments or chambers: An upper compartment (or upper chamber) above the coalescence promoting device 22; and a lower compartment (or lower chamber) below the coalescence promoting device 22. A space 30 is provided above the coalescence promoting device 22 to allow the hydrocarbon to gather in the upper most segment of the housing unit 12 for removal through the bleed out line 28. This space 30 can be defined as a coalesced hydrocarbon waste collection zone and generally encompasses a volume of the housing unit 12 between an upper wall of the housing unit 12 and the coalescence promoting device 22. In one embodiment, the space 30 can be defined as the area staring above the exit end of the coalescence promoting device 22. This space 30 can be or can include a gas-free zone, as will be described below with respected to the process steps, to allow for coalescence and removal of hydrocarbon from the filtration systems 10.

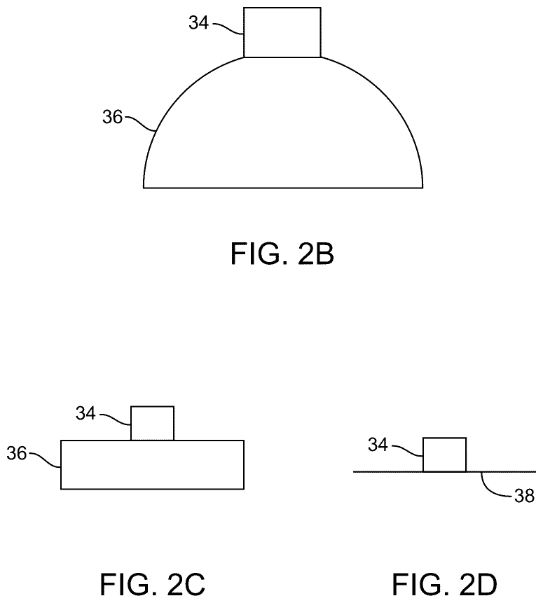

The coalescence promoting device 22 can be defined by two sections, an upper segment or fluid exit section and a lower segment or fluid entrance section. The upper segment can be of a constant dimension or diameter and the lower segment can be of a variable dimension or diameter. In one embodiment, the largest diameter of the lower segment, or the entrance diameter, closely corresponds or is equal to the diameter of the lower chamber of the housing unit 12. As illustrated by FIG. 2A, the coalescence promoting device 22 can include a hollow upper cylindrical segment 34 (having exit/outlet opening) of a constant inner diameter extending into a hollow lower conical or cone-shaped segment 36 (having entrance/inlet opening) of a variable inner diameter. The variable inner diameter increases away from the upper cylindrical segment 34 having the constant inner diameter. FIGS. 1 and 2A show an abrupt or angular transition between the upper segment 34 and lower segment 36. The transition between upper segment 34 and lower segment 36 can include a gradual transition, such as a curved sectional wall. Additionally, the upper segment 34 or lower segment 36 can have geometrical shapes other than cylindrical, conical, or circular cross-section. For example, the cross-section of upper segment 34 and/or lower segment 36 can be elliptical or oval instead of circular.

FIG. 2B illustrates an embodiment of the coalescence promoting device 22 having the hollow upper cylindrical segment 34 (having exit/outlet opening) of a constant inner diameter extending into a hollow lower domed-shaped segment 36 (having entrance/inlet opening) of a variable inner diameter. In another embodiment, as illustrated in FIG. 2C, the hollow upper segment 34 can be cylindrical having a constant inner diameter and the hollow lower segment 36 can be cylindrical having a constant inner diameter. The constant inner diameter of the upper segment 34 can be smaller than the constant inner diameter of the lower segment 36. FIG. 2D illustrates another embodiment where the lower segment is eliminated. The hollow upper cylindrical segment 34 is attached to a plate 38 for supporting the upper segment 34 on the housing unit 12 inner wall. In this embodiment, the upper segment 34 can be circular, elliptical, or oval in cross-section. The actuator 18 can run through the opening of the coalescence promoting device 22 to connect with the upper plate 14.

Coalescence promoting device 22 is designed to enhance the fluid hydrodynamics as the fluid passes through the coalescence promoting device 22 by exerting a predetermined and experimentally verified condition. These conditions can be intended to provide, by way of example, an optimum kinetic energy field, an optimum fluid regime, increasing population density, collision efficiency and coalescence of the dispersed phase, resulting in enhanced quality of the filtrate from the filtration system.

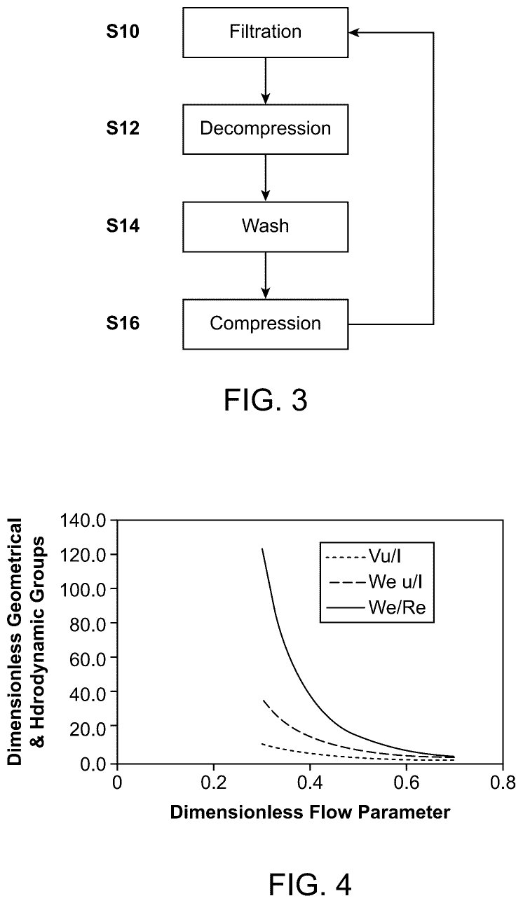

Referring now to FIG. 3, an embodiment of the process of the present invention is shown. The process includes a filtration cycle S10, a decompression step S12, a wash cycle S14, and a compression step S16, all of which can be repeated during a single filtration event. The process additionally includes a bleed step for removing coalesced hydrocarbon from the filtration system 10. The bleed step can be performed on a predetermined time cycle either automatically or manually. The bleed step can be performed during the filtration S10 and/or wash cycle S14.

In the filtration cycle S10, the filtration media 20 can be in a compressed state—meaning that the filtration media is compressed between the upper 14′ and lower 16 plates so as to create a porous gradient profile. Compression can be performed by moving the upper 14 and lower 16 plates closer together until a desired porous gradient profile is achieved. Over compression of the filtration media 20 can adversely affect the performance by causing the larger contaminants to clog the filter at the fluid entry point. On the other hand, under compression of the filter can reduce the effectiveness of the filter in capturing contaminants of smaller sizes. When the pore sizes in the filter are too big, smaller contaminants do not get adequately captured and filtered out. The proper compression force is typically determined by the type of contaminants that a user wants to capture and the porosity and compressibility of the filtration media. The compression ratio of the media is therefore in a range and is optimizable for a given medium and influent contaminant type, shape, and concentration to achieve best result. Referring back to FIG. 1, in one embodiment, upper plate 14 is actuated toward the lower plate 16—to its lower, compression state position 14′.

The carrier fluid in pumped into the chamber 12 via influent line 24 and supplied through the filtration media 20. The filtration media 20 captures a contaminant. After passing through the filtration media 20, the carrier fluid exits the chamber 12 as filtered fluid through the effluent line 26.

Next, when the filtration media 20 has reached its intended filtration capability or its contamination capture capacity, the filtration system 10 transitions to the wash cycle S14. Before the commencement of the wash cycle, the filtration media 20 can be transitioned from the compressed state to its decompressed state. Decompression can be performed by moving the upper 14 and lower 16 plates further away from each other to open the pores or matrix of the filtration media 20 to allow easier dislodgment and removal of the contaminant. Referring to FIG. 1, in one embodiment, upper plate 14 is actuated away from the lower plate 16—that is, from its compression state position 14′ to the illustrated decompressed state position 14. The distance between the upper plate 14 and lower plate 16 for the decompression state depends on the type of filtration media. The distance can vary from a maximum set distance that the actuator 18 can move the plates 14/16 away from each other to a distance less than the maximum distance as selected by a user.

After the filtration media 20 has reached its decompressed state, the wash cycle can begin. The wash fluid is supplied or pumped via influent line 24 and supplied through the expanded or decompressed filtration media 20. As indicated above, a separate wash influent line can be used that is different from the carrier fluid influent line. The wash fluid can be introduced at a flow rate to agitate the filtration media 20 and to dislodge and remove a contaminant from the filtration media 20. The wash fluid carrying the contaminant is purged out of the chamber 12 via the effluent line 26 or another line. During this wash cycle, no gasses, such as a scouring gas, are introduced into the chamber 12 or pumped into the wash fluid. Moreover, the wash fluid can be a gas-free type fluid. This is for eliminating any liquid-free zones at the top of the housing unit 12. In other words, the area between the upper wall of the chamber or housing unit 12 and coalescence promoting device 22 will be full of liquid and a gas-free zone. Elimination of a liquid-free zone on at the top of the chamber 12 allows for wash cycle discharge fluid to be single phase or essentially a single phase liquid and gas-free.

One significant benefit gained by elimination of the liquid-free zone includes reduction in the number of steps to be executed prior to initiation of the wash cycle, resulting in reduction of time period when filter is off-line and nonoperational. Second benefit is the simplification to the additional treatment required for the contaminated wash cycle fluid. Any gas phase carried by the wash fluid has to be further managed and subjected to special treatment, which may not be adequately available and require additional facilities and equipment.

After the wash cycle S14, the filtration media 20 can return back to its compressed state, and the filtration cycle S10 can begin. The upper plate 14 is actuated down to position 14′ and the carrier fluid is pumped back through the influent line 24 and into the chamber 12 for filtration.

While not bound by the following theory or any particular principles, it is believed the proposed system improves on the internal fluid hydrodynamic of the filtration system by providing compartmentalization of the internal space of the filtration vessel so that the vessel housing is comprised of upper and lower compartments. The two compartments will communicate fluidly through a mechanism, device or opening where the opening has a smaller diameter than the vessel housing. At a microscopic level, the filtration medium can be described as a porous medium where carrier fluid or continuous phase will flow through pores or channels within the porous medium, carrying suspended solids and dispersed liquid phase in the form of droplets, into the pore space. Solid particulate matter will collide with pore walls as traveling deeper into the filtration medium and will be separated by sieving mechanism when encountering pore channels smaller than its average diameter. Liquid phase on the other hand will be separated by impingement to the channel walls and sorption to the surfaces. The carrier fluid and dispersed fluid will travel at different speeds through the pores according to their mobility ratios and physical properties. Over time this phenomenon will results in separation and entrapment of the dispersed liquid phase within the porous space. As known in the art, the pore space will be occupied by the phase with higher wettability and affinity for the pore wall material. One example of such condition can be water mixed with hydrocarbon-based liquids such as what is typically found in the oilfield produced fluids. It is well known that hydrocarbons tend to have more affinity for filtration medium of naturally organic, synthetic organic or inorganic materials than water. The affinity of hydrocarbons for certain surfaces is measured by their relevant contact angle and interfacial tension and they are predominantly demonstrating higher affinity for typical filtration material than water and therefore are classified as the wetting phase. This phenomenon is the primary coalescence of the dispersed phase. In the pore space, the saturation concentration of the wetting phase and non-wetting phase combined will approach unity. Thus, there exist a competing relationship between maximum saturation concentration of wetting phase and a corresponding minimum saturation of the non-wetting phase. Once the porous medium reaches its maximum imbibition capacity to adsorb the dispersed wetting phase, pressure gradient across the filtration medium will reach its maximum, since the pore channels available to the flow are mostly occupied by the wetting phase. From this point forward, the fluid velocity will be higher through the unoccupied volume of the pore channels. At the top surface of the filtration medium, where the filtration medium is in contact with filtrate, drag forces induced by flow of the continuous phase, leaving the filtration medium at higher velocity relative to the wetting phase, will rupture the wetting phase and carry the broken-off droplets co-currently in the direction of the flow. It has been demonstrated in the art that droplet break-up is dependent on the flow regime. It has been postulated that in laminar flow regime these forces are predominantly viscous shear forces while in turbulent flow regimes the forces are dominant by inertial forces. Also known in the art is the fact that qualification of the balance between the viscous and inertial forces can be performed by evaluation of the dimensionless groups such as the Reynolds, Webber, Capillary and Boron numbers among others. Another phenomenon known in the art is the effect of turbulence on collision and collision efficiency between the droplets. It is known that in turbulent flow regime, the collision efficiency between droplets is directly proportional to microscopic eddy and the localized energy formed. Yet another fact known in the art indicates an increase in population density of the dispersed phase will result in increased collision efficiency and thus promoting coalescence.

For a preferred example of an embodiment, tests were conducted to calculate the hydraulic Reynolds number of the lower chamber at the entrance of the coalescence promoting device and equivalent Reynolds number at the exit of the coalescence promoting device (Table 1). For this particular experiment, the coalescence promoting device has caused a shift in the hydraulic flow regime towards the preferred turbulent flow regimes, which promotes coalescence between the dispersed hydrocarbon phase drops. Unset of transient to turbulent flow regime promotes turbulent eddies which in turn increases collision probability and induce higher rate of successful coalescence. The higher rate of coalescence was both visually observed and measured by instrumentation throughout the test.

TABLE 1

| Re (l) | Flow | Re (u) | Flow |
|---|---|---|---|
| Hyd. | Regime | Hyd. | Regime |
| 0 | Laminar | 0 | Laminar |
| 324 | Laminar | 1016 | Laminar |
| 648 | Laminar | 2031 | Laminar |
| 972 | Laminar | 3047 | Transient |
| 1296 | Laminar | 4062 | Transient |
| 1621 | Laminar | 5078 | Turbulent |
| 1945 | Laminar | 6094 | Turbulent |
| 2269 | Transient | 7109 | Turbulent |
| 2593 | Transient | 8125 | Turbulent |
| 2917 | Transient | 9140 | Turbulent |
| 3241 | Transient | 10156 | Turbulent |
| 3565 | Transient | 11171 | Turbulent |
| 3889 | Turbulent | 12187 | Turbulent |

The embodiment can be generalized in a broader range of operation as it provided in Table 2 and corresponding FIG. 4. The preferred ratio of the diameter of the lower chamber of the filtration housing, which can closely correspond to the entrance diameter of the coalescence promoting device, with the diameter of the opening exiting the device into the upper chamber of the filtration housing, may be selected according to the relationship in Table 2 and FIG. 4. In a preferred embodiment the geometrical relationship can be select such that ratio of the upper (exit) and lower (entrance) hydraulic Reynolds number is between 1.4 to 3.3, and more preferably between 2.2 to 3.1 and most preferably 2.9. This ratio refers to the Reynolds number during the filtration cycle.

TABLE 2

| Re u/l | V u/l | Re/We |
|---|---|---|
| 1.4 | 2.0 | 0.49 |
| 1.7 | 2.8 | 0.36 |
| 2.0 | 4.0 | 0.25 |
| 2.1 | 4.3 | 0.23 |
| 2.2 | 4.7 | 0.21 |
| 2.3 | 5.2 | 0.19 |
| 2.4 | 5.7 | 0.18 |
| 2.5 | 6.3 | 0.16 |
| 2.6 | 6.9 | 0.14 |
| 2.8 | 7.7 | 0.13 |
| 2.9 | 8.7 | 0.12 |
| 3.1 | 9.8 | 0.10 |
| 3.3 | 11.1 | 0.09 |

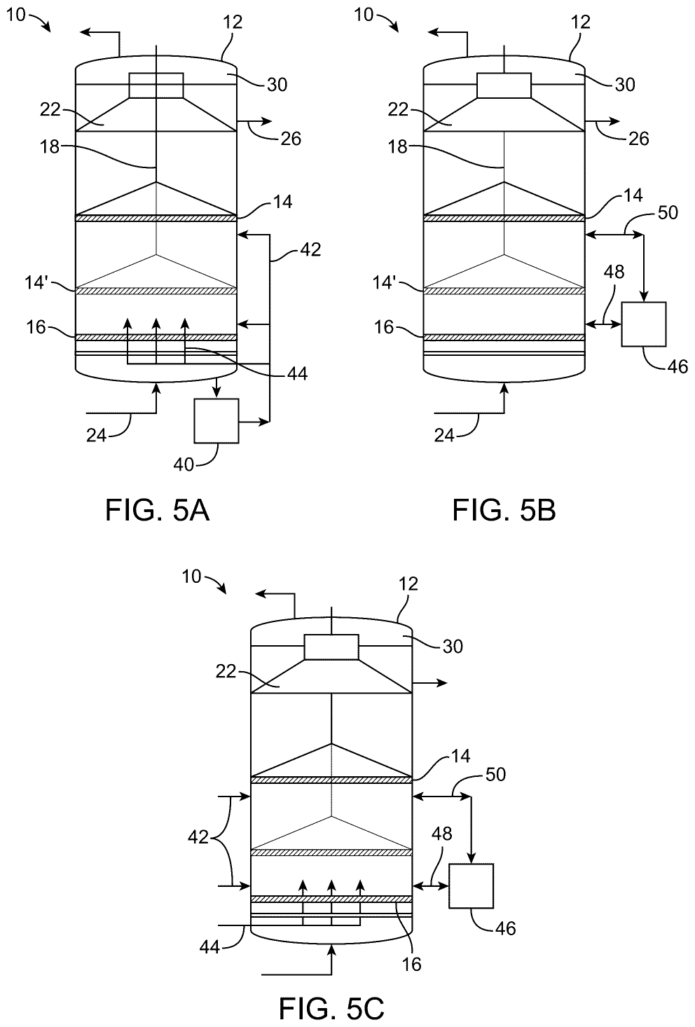

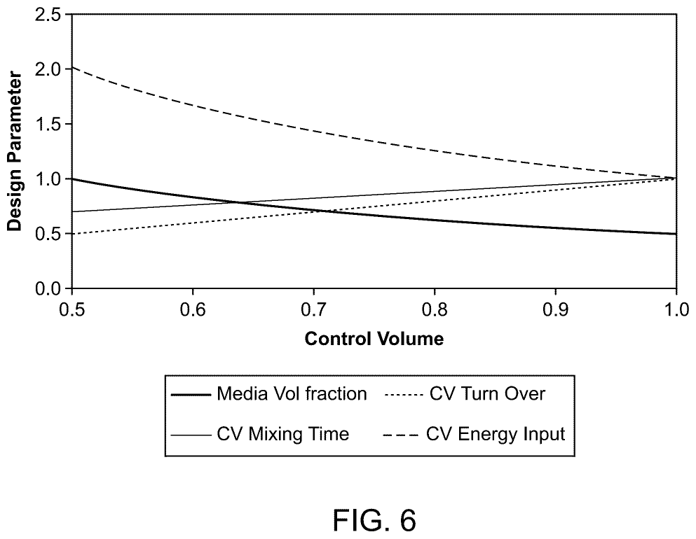

FIGS. 5A and 5B illustrate modified versions of the filtration system 10 of FIG. 1. FIG. 5C is the combination of the embodiments of FIGS. 5A and 5B. FIGS. 5A, 5B, and 5C include the same elements referred to by the same reference numbers, including the chamber or housing unit 12; the upper perforated plate 14/14′ (decompressed state 14 and compressed state 14′); the lower perforated plate 16; the actuator 18; the filtration media 20; the coalescence promoting device 22; the influent or inlet line 24; the effluent or outline line 26; bleed out line 28; and the space 30. As with embodiment of FIG. 1, the space 30 can be defined as a coalesced hydrocarbon collection zone and generally encompasses a volume of the housing 12 between an upper wall of the housing 12 and the coalescence promoting device 22. In one embodiment, the space 30 can be defined as the area staring above the exit end of the coalescence device 22. This space 30 can be or can include a gas-free zone.

In the embodiment of the filtration system 10 of FIG. 5A, a fluid circulating device 40, such as a pump, is in communication with the housing unit 12. The circulating device 40 can be an external device to the housing unit 12. The circulating device 40 receives at least a volume of the wash fluid supplied into the housing unit 12 and re-supplies the wash fluid via at least one radial nozzle 42 and at least one axial nozzle 44 to the filtration media 20. The axial and radial jets can work simultaneously or intermittently in supplying the fluid. The radial nozzle(s) 42 can be horizontally configured or aligned and the axial nozzle(s) can be vertically configured or aligned. Two radial nozzles 42 and three axial nozzles 44 are depicted by the arrows. The radial nozzles 42 can penetrate through the housing unit 12. The axial nozzles 44 can penetrating through the lower perforated plate 16. The flow of the wash fluid between the radial 42 and axial 44 nozzles can be controlled by a flow restricting device (not illustrated), as is known in the art. Flow restricting devices include, but are not limited to, orifice plates, manual valves, or automated flow control valves. Thus, the wash fluid flow split ratio can be adjusted or controlled to a predetermined ratio.

In one embodiment, the radial nozzle(s) 42 is positioned above the lower perforated plate 16 for supplying the wash fluid directly to the filtration medial 20. In one embodiment, the radial nozzle(s) 42 is positioned below the upper perforated plate 14 for supplying the wash fluid directly to the filtration medial 20. The radial nozzle(s) 42 can be positioned on the housing unit 12 at an elevation between the upper 14 and lower 16 perforated plates where the plates are arranged to provide the decompressed state for the filtration media. In one embodiment, the radial nozzle(s) 42 is positioned on the housing unit 12 between the upper 14 and lower 16 perforated plates when the plates are arranged at a maximum distance from one another—for example, the distance the actuating mechanism 18 is configured to move the plates with respect to each other.

In the embodiment of FIG. 5A, the carrier fluid in need of filtration can be directed into the housing unit 12 of the filtration system 10 to filter the carrier fluid with the filtration media 20 in the compressed state. The fluid that has been filtered by the filtration media 20 is discharged out of the housing unit 12. The wash fluid can be directed into the housing unit 12 for washing the filtration media 20 in the decompressed state. The wash fluid is discharged out of the housing unit 12 to remove a contaminant washed from the filtration media 20. The wash cycle incorporates the radial 42 and axial 44 nozzles or a plurality of radial and axial nozzles. During the wash cycle, at least a volume of the wash fluid is circulated into device 40 and supplied through the plurality of axial and radial nozzles.

In the embodiment of the filtration system 10 of FIG. 5B, an external flow loop circulating device 46 for circulating the wash fluid out of the housing unit 12 and back into the housing unit 12 is provided. The external flow loop circulating device 46 has a circulating inlet line for receiving the wash fluid from the housing unit 12 and a circulating outlet line for supplying the wash fluid back into the housing unit. In one embodiment, the external flow loop circulating device 46 can be a circulating pump. The external circulating pump can be any low shear pump such as, but not limited to, progressive cavity pumps, a lobe pump, a gear pump, or a diaphragm pump. In one preferred embodiment the external circulating device is a recessed impeller vortex pump. The inlet is either of reference numbers 48 or 50 and the outlet is the other (i.e., the inlet can be positioned below or above the outlet). In one embodiment, the inlet and outlet 48 and 50 are in communication with or coupled to the housing unit 12 such that the inlet to the flow circulating device 46 can be placed just above the lower perforating plate 16 and the outlet can be at a higher elevation and below the upper 14 perforating plate (e.g., when the plates are arranged to provide the decompressed state for the filtration media.) In one embodiment, the inlet and outlet lines 48 and 50 are in communication with or coupled to the housing unit 12 such that the outlet to the flow circulating device 46 can be placed just above the lower perforating plate 16 and the inlet can be at a higher elevation and below upper 14 perforating plate (e.g., when the plates are arranged to provide the decompressed state for the filtration media.) The inlet and the outlet can be positioned between the upper 14 and lower 16 perforated plates when the plates are in the decompressed position. The inlet and outlet can be positioned between the plates when the plates are arranged at a maximum distance from one another—for example, the distance the actuating mechanism 18 is configured to move the plates with respect to each other. During the wash cycle, the fluid in the control volume between the upper 14 and lower 16 perforated plates is circulated through the fluid circulating device 46 and back into the control volume between the upper 14 and lower plates 16.

It is believed that the embodiments of FIGS. 5A and 5B improve the effectiveness of the wash cycle as it relates to operational parameters such as, but not limited to, duration of wash cycle and waste generated as the result of wash cycle operation. The intent of the wash cycle is to clean the filtration medium from residue. The common practice for cleansing the filtration medium from deposited residue for static filter media beds are mechanically induced or hydraulically induced shear to break a part the static filter medium. The static filter medium can, for example, comprise of granulated organic and inorganic material such as sand, organic base solids such coal and anthracite, or granulated plant-based solids such as nutshell or wood based granulated carbonized particles. One common characteristic of these examples of static bed filtration media is their negative buoyancy with respect to the continuous phase. In contrast, filtration media with neutral or positive buoyancy as compared to continuous phase filtration medium, will be dynamic throughout the filtration tank unless they are held in place by applying force, whether mechanical compression or hydraulically induced drag forces as the result of high rate of filtration. The embodiments provided here are applicable to both class of the filtration media but are intended to particularly address the special challenges when filtration medium is neutrally buoyant or positively buoyant.

One of the challenges to design an effective cleansing method for this class of filtration media is that the forces which hold the media to gather must be neutralized. This can be accomplished by eliminating the hydraulicly induced drag forces induced by the flow of carrier fluid or continuous fluid or mechanically exerted compression forces, which holds the media in place. After neutralizing these forces, the filtration bed comprised of multitude of particulate or parts will disintegrate, meaning the buoyancy forces acting on each particulate no longer are neutralized by onsite forces. Thus, the particles are free to move about the holding tank. This movement of filter medium particles, if not controlled, will exert a distance between the buoyant filter medium particles. Therefore, the ability of the particulate filter medium to be exposed to any meaningful hydraulicly or mechanically induced shear during cleansing wash cycle is significantly diminishes resulting in ineffective cleansing of the medium particles which in practical filtration system operation manifests in high frequency wash cycles and generating large quantity of waste. It is believed that the embodiment of FIG. 5A addresses these inherent problems. FIG. 5B illustrates a filtration system having submerged side entry liquid jets, exerting a specific amount of energy to a finite control volume which maintains a critical concentration or critical volume fraction of filtration media particles which are negatively, positively, or neutrally buoyant. The systems can maximize collision efficiency between filter media particles and reduces the time required for wash cycle and further reduces waste generated as the result.

The following example is intended to demonstrate the relationship between critical design parameters incorporated in an experimental filtration system designed based on the principles and improvements described above.

The Max Control Volume was 422 gal; Jet Froude/Reynolds was 0.41-9.85; and Radial/Axial jet flow rate split ratio was 1:1.47.

TABLE 3

| Control | | | | | | |
|---|---|---|---|---|---|---|
| volume | | | | | | |
| (CV) | 0.5 | 0.6 | 0.7 | 0.75 | 0.8 | 1.0 |
| Media Vol. | 1.0 | 0.9 | 0.8 | 0.7 | 0.6 | 0.5 |
| Fraction | | | | | | |
| CV Turn | 0.5 | 0.6 | 0.7 | 0.8 | 0.8 | 1.0 |
| Over | | | | | | |
| CV Mixing | 0.7 | 0.8 | 0.8 | 0.9 | 0.9 | 1.0 |
| Time | | | | | | |
| CV Energy | 2.0 | 1.7 | 1.5 | 1.3 | 1.2 | 1.0 |
| Input | | | | | | |

The results in Table 3 are graphical represented in FIG. 5. The control volume parameter range is between 0.5 to 1.0 and represents normal filtration cycle volume at minimum value and the corresponding wash cycle volume at its maximum volume. Media volume fraction reversely follows the CV expansion or contraction, representing the concentration of the media at a given finite volume in the tank. The desired value for media volume fraction occurs when media is at its highest concentration to promote impingement and increased frequency of effective collisions during wash cycle. CV turn-over and CV mixing time are both indicators of number of CV displacements during wash cycle. Both variables are desirable at lower range since lower turn-over time for a given CV is an indicator of shorter wash cycle and therefore smaller volumes of waste generated. CV energy input is the design variable which controls the energy input of the nozzles to the system. The desired value for this design parameter is higher values as more energy input to the system is indicative of stronger velocity gradients exerted by the jets inducing higher energy to the media particles through momentum and hydraulic drag. Therefore, there is a desirable range for the filtration system incorporated with submerged side entry jets where all other design variables are at their optimum value. In a preferred embodiment the control volume ranges between 0.6 to 0.8, with corresponding media volume factions ranging in 0.6-0.9, turn-over rate rage of 0.6-0.8, mixing time range of 0.8-0.9 and nozzle energy input of 1.2-1.7. More desirably control volume will range 0.7-0.8 with all other corresponding design variable ranges indicated in Table 3. Most desirably the control volume ranges within 0.75-0.8 with all other corresponding variables as indicated in Table 3.

As described above, the embodiment of FIG. 5B has an external circulating device, which re-circulates the fluid and at least a portion of the media through a suction outlet from the control volume, propels the fluid and the media through the external circulating device, and ejects the fluid and the media back into the control volume of the tank. The external circulating device propels the neutrally buoyant, positively buoyant, and negatively buoyant media with the nozzles strategically located so that the buoyancy of the media does not interfere with effective recirculation of at least a portion of the filtration media through the device. In one none limiting example applicable to the positively buoyant filtration media, the pump suction can be place with the control volume and in an immediate elevation below the upper perforated plate to capture the media which is floating and resting at the elevation of upper perforated plate. In another example for negatively buoyant media, the suction can be placed within the control volume and immediately above the lower perforated plate where the negatively buoyant media rests.

In yet another embodiment, as depicted in FIG. 5C, an external circulating device, which re-circulates the fluid and at least a portion of the media through a suction outlet from the control volume, propels the fluid and the media through the external circulating device, and ejects the fluid and at least a portion of the media back into the control volume of the tank, while axial and radial jets either simultaneously or intermittently inject high energy liquid stream into the control volume to provide additional mixing energy to the neutrally buoyant, positively buoyant or negatively buoyant filtration media.

While several particular forms, variations, and embodiments of the inventions have been illustrated and described, it will also be apparent that various modifications can be made without departing from the scope of the inventions. It is also contemplated that various combinations or sub-combinations of the specific features and aspects of the disclosed embodiments can be combined with or substituted for one another in order to form varying modes of the inventions.

1. A hydrocarbon filtration system for removing a contaminant, comprising:
a housing unit;
a porous compressible filtration media disposed within the housing unit;
lower and upper perforated plates in between which the porous compressible filtration media is disposed, wherein at least one of the upper or lower perforated plate is movable relative to the other perforated plate for compressing and decompressing the porous compressible filtration media;
an inlet line configured to receive a wash fluid for removing a contaminant from the porous compressible filtration media when the porous compressible filtration media is in a decompressed state;
an outlet line through which the wash fluid is discharged along with the removed contaminant; and
a coalescence promoting device positioned within the housing unit and above the upper perforated plate, the coalescence promoting device is configured to promote the coalescence of a hydrocarbon in the housing unit.

2. The hydrocarbon filtration system of claim 1, additionally comprising a second outlet line configured to be used to remove coalesced hydrocarbon from the housing unit.

3. The hydrocarbon filtration system of claim 1, wherein the housing unit comprises a coalesced hydrocarbon collection zone above the coalescence promoting device and below an upper wall of the housing unit, the coalesced hydrocarbon collection zone providing an area in an upper most area of the housing unit where the coalesced hydrocarbon is collected.

4. The hydrocarbon filtration system of claim 1, wherein the coalescence promoting device comprises a hollow upper cylindrical segment of a constant inner diameter extending into hollow lower conical segment of a variable inner diameter, the variable inner diameter increases away from the upper cylindrical segment of the constant inner diameter.

5. The hydrocarbon filtration system of claim 1, wherein the coalescence promoting device comprises a hollow upper segment having a constant diameter extending into hollow lower segment having variable diameter, wherein a largest diameter of the hollow lower segment is equal to an inner diameter of the housing.

6. A method of filtering a contaminant from a carrier fluid, comprising:
directing an carrier fluid in need of filtration into the housing unit of the filtration system of claim 1 so as to filter the fluid with the filtration media;
discharging the fluid that has been filtered by the filtration media out of the housing unit;
directing a wash fluid into the housing unit for washing the filtration media;
discharging the wash fluid out of the housing unit to remove a contaminant washed from the filtration media; and
periodically removing a coalesced hydrocarbon from the housing unit.

7. The method of claim 6, wherein
during the directing the carrier fluid the filtration media is in a compressed state; and
during the directing the wash fluid the filtration media is in a decompressed state, and wherein
during the directing the wash fluid no gases are introduced into the wash fluid or the housing unit so as to avoid having a liquid-free zone in the housing unit in an area above the coalescence promoting device.

8. The method of claim 7, wherein
the compressed state is performed by actuating the upper plate down and towards the lower plate so as to compress the filtration media to create a porosity gradient in the filtration media for removal of the contaminant; and
the decompressed state is performed by moving the upper plate up and away from the lower plate to cause the filtration media to expand from the compressed state to the decompressed state so as to facilitate the removal of the contaminant captured by the filtration media by the wash fluid.

9. The method of claim 6, wherein during the directing the wash fluid and discharging the wash fluid, a space below an upper wall of the housing unit and above the coalescence promoting device is free from any gases.

10. A method of treating a hydrocarbon containing fluid, comprising:
performing a filtration cycle with a chamber housing a filter to filter a contaminant from a hydrocarbon containing fluid; and
performing a wash cycle to wash the filter and to remove the contaminant from the filter, wherein during the wash cycle an upper segment of the chamber housing below an upper wall of the chamber housing is a gas-free zone.

11. The method of claim 10, wherein
the chamber housing includes a coalescence promoting device to promote the coalescence of the hydrocarbon to facilitate the collection of the coalesced hydrocarbon in the gas-free zone and removal of the coalesced hydrocarbon from the chamber housing, and
wherein the method further comprises performing removal of the coalesced hydrocarbon from the chamber housing.

12. The method of claim 11, wherein the removal of the coalesced hydrocarbon is performed during the wash cycle.

13. The method of claim 11, wherein the removal of the coalesced hydrocarbon is performed at least once during the filtration cycle and is performed at least once during the wash cycle.

14. The method of claim 11, wherein the coalescence promoting device comprises a hollow upper cylindrical segment of a constant diameter extending into a hollow lower conical segment of a variable diameter, the variable diameter increases away from the upper cylindrical segment of the constant diameter.

15. The method of claim 10, additionally comprising
performing a decompression step prior the wash cycle to decompress the filter; and
performing a compression step after the wash cycle and before the filtration cycle to compress the filter.

16. The method of claim 15, wherein the chamber houses a perforated upper plate and a perforated lower plate positioned at a distance below the perforated upper plate, the filter being disposed between the perforated upper and lower plates, and wherein the perforated upper plate is moved away from the perforated lower plate for the decompression step and the perforated upper plate is moved towards the perforated lower plate for the compression step.

17. The method of claim 10, wherein during the wash cycle a wash fluid is introduced into the chamber housing via an inlet line, is passed through the filter for removal of the contaminant, and is discharged through an outline line, with the proviso that no gas is introduced into the chamber housing during the wash cycle or added to the wash fluid so as to create the gas-free zone in the upper segment of the chamber housing.

18. (canceled)

19. (canceled)

20. (canceled)

21. (canceled)

22. (canceled)

23. (canceled)

24. (canceled)

25. (canceled)

26. (canceled)

27. (canceled)

28. (canceled)
